(19) United States
(12) Patent Application Publication
(10) Pub. No.: US 2021/0034221 A1
(43) Pub. Date: Feb. 4, 2021

(54) METHOD AND SYSTEM FOR GENERATING 3D IMAGE FROM 2D IMAGE

(71) Applicant: Social Nation, Inc., Millbrae, CA (US)

(72) Inventors: Prachaya Phaisanwiphatpong, Millbrae, CA (US); Michael Rucker, Redwood City, CA (US); Sittiphol Phanvilai, Millbrae, CA (US)

(21) Appl. No.: 16/525,471

(22) Filed: Jul. 29, 2019

(51) Int. Cl. G06F 3/0481; G06F 9/451; G06Q 30/02; G06T 17/20; G06T 15/04; G06T 7/50; G06F 3/0484

(52) U.S. Cl. CPC G06F 3/04815; G06F 9/451; G06Q 30/0276; G06Q 30/0277; G06Q 30/0247; G06T 2200/24; G06T 15/04; G06T 7/50; G06F 3/04847; G06T 2207/20081; G06T 2207/10028; G06T 17/20

(57) ABSTRACT

Systems and methods for generating and displaying a three dimensional (3D) images are described. The systems and methods may provide for receiving a two dimensional (2D) photo image and a depth map, the depth map comprising a 2D depth image including a plurality of pixels, each pixel representing a depth value for a corresponding pixel of the 2D photo image, constructing a 3D mesh from the depth map, the 3D mesh comprising a 3D representation of the depth map and comprising a plurality of vertices and edges, mapping the 2D photo image as a texture on the 3D mesh to create a 3D image, interpolating a plurality of missing pixel values in the texture from adjacent pixel value, and rendering the 3D image.

### BACKGROUND

The following relates generally to image generation, and more specifically to generating and displaying three dimensional (3D) images.

Both two dimensional (2D) and 3D images are used in a wide variety of applications. In some cases, it is desirable to create a 3D image from a 2D image. For example, advertisers often use 2D images to create online advertising banners. This is because 2D technology is provided out-of-the-box by web browsers and does not require a special system to design and implement the ads. However, ad banners created using 2D images may not be as effective as 3D images at drawing attention. Furthermore, creating 3D images using existing techniques may be costly and time consuming. Therefore, there it would be desirable for advertisers and other producers and consumers of images to efficiently generate 3D images.

### SUMMARY

A computer-implemented method, apparatus, and non-transitory computer readable medium for generating and displaying a three dimensional (3D) images are described. The computer-implemented method, apparatus, and non-transitory computer readable medium may provide for receiving a two dimensional (2D) photo image and a depth map, the depth map comprising a 2D depth image including a plurality of pixels, each pixel representing a depth value for a corresponding pixel of the 2D photo image, constructing a 3D mesh from the depth map, the 3D mesh comprising a 3D representation of the depth map and comprising a plurality of vertices and edges, mapping the 2D photo image as a texture on the 3D mesh to create a 3D image, interpolating a plurality of missing pixel values in the texture from adjacent pixel value, and rendering the 3D image.

Another computer-implemented method, apparatus, and non-transitory computer readable medium for generating and displaying a 3D images are described. The computer-implemented method, apparatus, and non-transitory computer readable medium may provide for receiving a 2D photo image and a depth map, constructing a 3D mesh from the depth map, mapping the 2D photo image as a texture on the 3D mesh to create a 3D image, and rendering the 3D image.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 shows an example of an image generation system in accordance with aspects of the present disclosure.

FIG. 2A shows an example of an image generation module in accordance with aspects of the present disclosure.

FIG. 2B shows an example of a client device in accordance with aspects of the present disclosure.

FIG. 3A shows an example of an overview of a process for generating a three dimensional (3D) image in accordance with aspects of the present disclosure.

FIG. 3B shows an example of an overview of a process for generating a 3D model in accordance with aspects of the present disclosure.

FIG. 3C shows an example of an ad server in accordance with aspects of the present disclosure.

FIG. 4 shows an example of a process for generating a 3D image in accordance with aspects of the present disclosure.

FIGS. 5 through 6 show examples of a process for generating and displaying a 3D images in accordance with aspects of the present disclosure.

FIG. 7 shows an example of generating a depth map in accordance with aspects of the present disclosure.

FIG. 8 shows an example of a user interface showing an original two dimensional (2D) image in accordance with aspects of the present disclosure.

FIG. 9 shows an example of a user interface showing a depth map in accordance with aspects of the present disclosure.

FIG. 10 shows an example of a user interface showing a slider element in accordance with aspects of the present disclosure.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

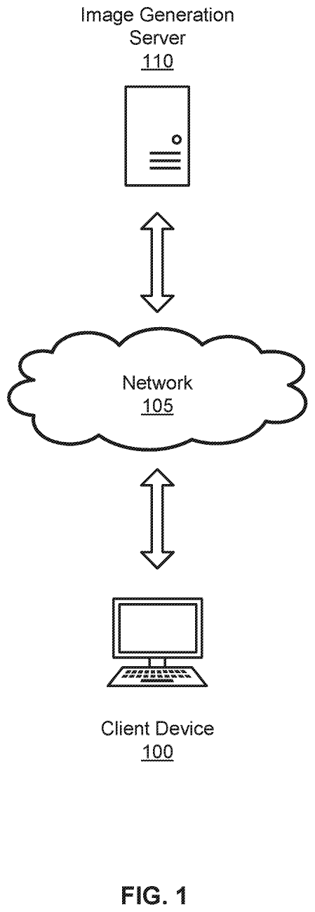

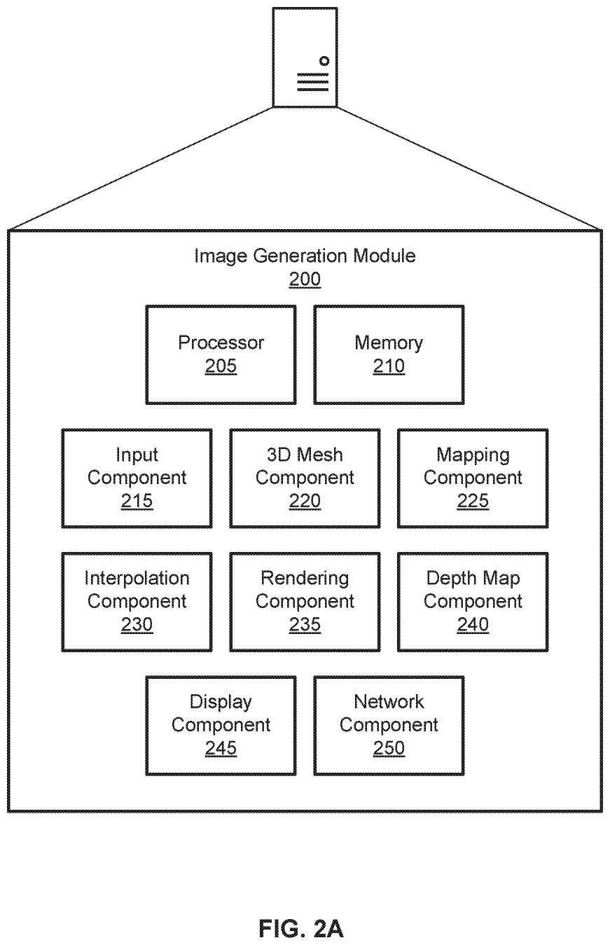

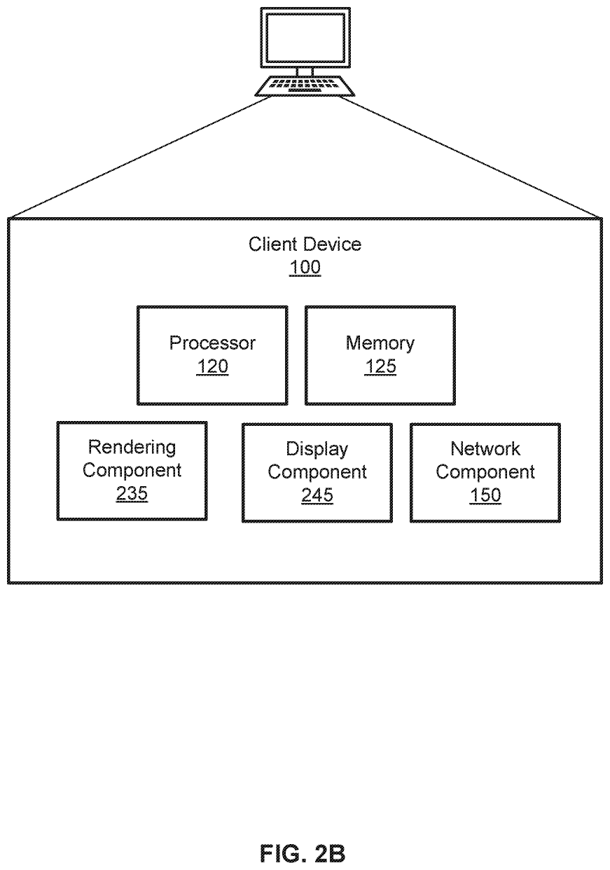

FIG. 1 shows an example of an image generation system in accordance with aspects of the present disclosure. The example shown includes client device 100, network 105, and image generation server 110. In one example, the client device 100 is used (e.g., by a person creating an advertising banner) to upload image data to the image generation server 110 via the network 105. Image generation server 110 may be an example of, or include aspects of, the corresponding element or elements described with reference to FIG. 2.

In one embodiment, the image generation system takes a 2D photo and an associated depth map graphic as an input (e.g., via the client device 100). A depth graphic (or depth map) may be in the form of a grayscale photo where the brightness of each pixel represents the depth value of the original image at the same position. After uploading the images, the image generation system processes the input into a 3D experience. Such experiences may then be served inside ad banners (e.g., using a web based renderer).

Embodiments of the image generation system provide for ease-of-creation—that is, a process to create 3D experience that may be performed from a wide variety of 2D photo editing software applications. The system may also provide for improved scale-of-distribution—that is, distributing the 3D experience may be scalable and feasible within the current digital advertisement ecosystem. Thus, for example, the system may utilize common web-based protocols.

Thus, the present disclosure provides for an image generation system that takes a 2D image and a depth map as input and provides an output that may be distributed via common web protocols and languages including hypertext markup language (HTML). In one embodiment, an end-to-end web application is provided that enables the creation and distribution in a single interface

In some embodiments, the system may be integrated with an existing ad building and editing software. For example, the image generation system workflow can be integrated as a plugin or custom template implementation. In some embodiments, an HTML output associated JavaScript renderer operates as a generic web component that can be used outside an ad application (for example, embedded as a 3D photo on a website). Embodiments of the disclosure also provide for a 2D overlay feature. For example, additional 2D experiences can be overlaid on top of 3D ads as part of the workflow described herein.

Thus, the present disclosure provides efficient means of creating 3D images, including 3D advertisement experiences. 3D ad experiences grab audiences' attention effectively, which makes the ad messages and visual graphics stand out. 3D ads may also be clearly distinguishable from surrounding content, which results in more effective advertising.

In some embodiments, 3D Photos are created from existing 2D image editing software (photoshop, etc.). When the inputs are implemented in the described system, 3D ads may be created without 3D models (i.e., from a 3D modeling software), which may increase the ease of 3D ad creation.

FIG. 2A shows an example of an image generation module 200 in accordance with aspects of the present disclosure. Image generation module 200 may be an example of, or include aspects of, the corresponding element or elements described with reference to FIG. 1. In an embodiment, image generation module 200 comprises image generation server 110. In other embodiments, image generation module 200 is a component or system on client device 100 or peripherals or third-party devices. Image generation module 200 may comprise hardware or software or both.

Image generation module 200 may include processor 205, memory 210, input component 215, three dimensional (3D) mesh component 220, mapping component 225, interpolation component 230, rendering component 235, depth map component 240, display component 245, and network component 250.

A processor 205 may include an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor 205 may be configured to operate a memory array using a memory controller. In other cases, a memory controller may be integrated into processor 205. The processor 205 may be configured to execute computer-readable instructions stored in a memory to perform various functions related to generating 3D images.

Memory 210 may include random access memory (RAM), read-only memory (ROM), or a hard disk. The memory 210 may be solid state or a hard disk drive, and may store computer-readable, computer-executable software including instructions that, when executed, cause a processor to perform various functions described herein. In some cases, the memory 210 may contain, among other things, a BIOS which may control basic hardware or software operation such as the interaction with peripheral components or devices. In some cases, a memory controller may operate memory cells as described herein.

Input component 215 may receive a two dimensional (2D) photo image and a depth map. In some cases, the depth map comprises a 2D depth image including a set of pixels, each pixel representing a depth value for a corresponding pixel of the 2D photo image. Input component 215 may receive the depth map as an uploaded file from a user. Input component 215 may also receive user input in a web browser and changing a user viewpoint for viewing the 3D image in response to the user input.

Input component 215 may receive the 2D photo image as an uploaded file from a user. Input component 215 may also receive the depth map as an uploaded file from the user. Input component 215 may also receive a selection of a banner ad format by the user. Input component 215 may also receive a user input to initiate generation of the 3D image.

3D mesh component 220 may construct a 3D mesh from the depth map. In some cases, the 3D mesh comprises a 3D representation of the depth map and includes a set of vertices, edges, and faces. Mapping component 225 may map the 2D photo image as a texture on the 3D mesh to create a 3D image.

Interpolation component 230 may interpolate a set of missing pixel values in the texture from other pixel values in the texture, such as adjacent pixel values. Rendering component 235 may render the 3D image.

Depth map component 240 may generate, by a machine learning depth prediction model, the depth map from the 2D photo image. The machine learning depth prediction model may be trained on a dataset of images and corresponding depth maps.

In other examples, the depth map is generated simultaneously with the 2D photo image by a camera with a depth sensing system. The depth sensing system may comprise, for example, an infra-red sensor, sonar, or other sensors. The depth sensing data captured by the sensor may be used to generate a depth map that is stored in the same file as the 2D photo image, in some cases as EXIF data.

Display component 245 may display a visual element, the visual element including a portion of the 2D photo image and a portion of the depth map. Display component 245 may also display a slider on top of the visual element, where the slider is configured to be adjustable and allow increasing and decreasing the area of the visual element including the 2D photo image and the depth map.

Display component 245 may also display the 3D image in an online banner advertisement. Display component 245 may display the 3D image using a hypertext markup language (HTML), such as HTML5, and a programming language such as JavaScript. Display component 245 may also display a 2D overlay on top of the 3D image, the 2D overlay including one or more interactive use interface elements.

Network component 250 may transmit the online banner advertisement to an online advertising network. Network component 250 may also receive payment from the online advertising network per click on the online banner advertisement.

FIG. 2B shows an example of a client device 100 in accordance with aspects of the present disclosure. Client device 100 may be an example of, or include aspects of, the corresponding element or elements described with reference to FIG. 1.

Client device 100 may include processor 120, memory 125, rendering component 235, display component 245, and network component 150. Some or all of these components are optional. Processor 120, memory 125, and network component 150 may have the same components and functionalities as processor 205, memory 210, and network component 250.

In some embodiments, an external server such as ad server 335 transmits an ad banner 350 to the client device 100. The ad banner 350 may comprise a 3D model 330. The rendering component 235 and display component 245 on the client device 100 may perform the rendering of the 3D model 330 and the display of it to the user. In some embodiments, the rendering component 235 and display component 245 may comprise parts of a web browser.

In other embodiments, client device 100 may lack a rendering component 235 and display component 245. An ad server 335 may include rendering component 235 and display component 245 and perform the rendering and display of the 3D model 330 on the server side. The ad server 335 may then stream the video and user experience to the client device 100. Input on the client device 100 may be transmitted to the ad server 335 to affect the rendering and display.

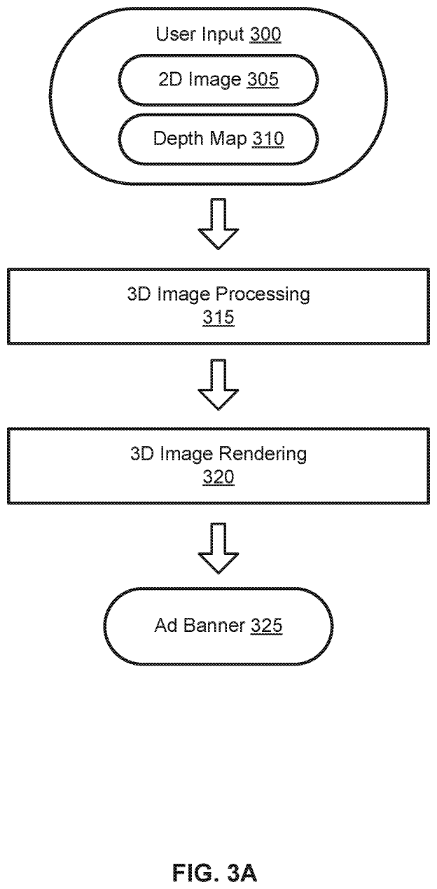

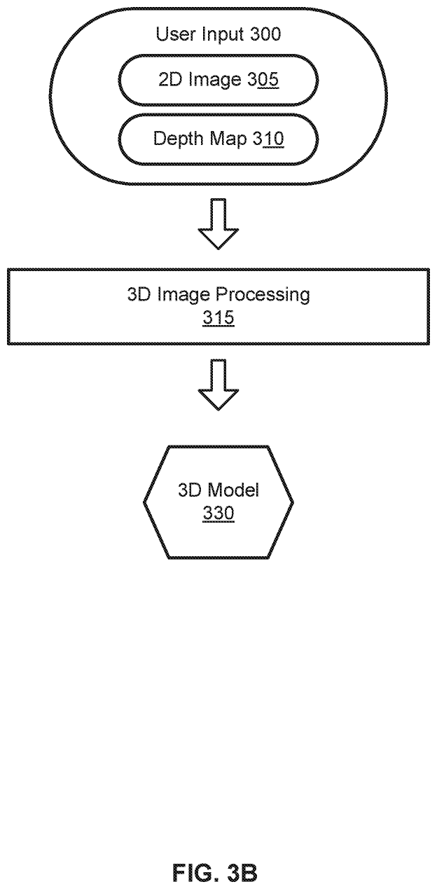

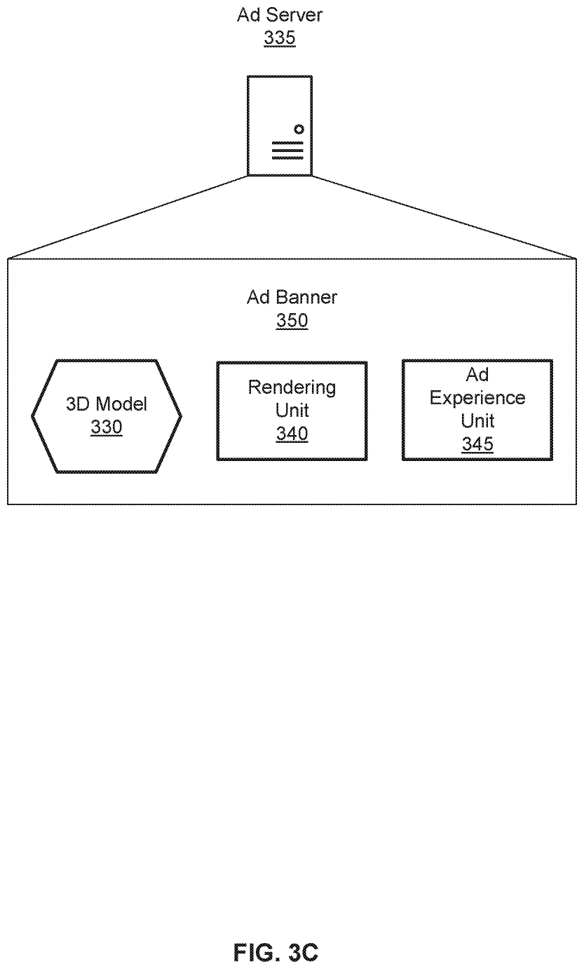

FIG. 3A shows an example of an overview of a process for generating and rendering a 3D image in accordance with aspects of the present disclosure. The example shown includes user input 300, which is processed by the functions of 3D image processing 315 and 3D image rendering 320 to create ad banner 325 (i.e., the output).

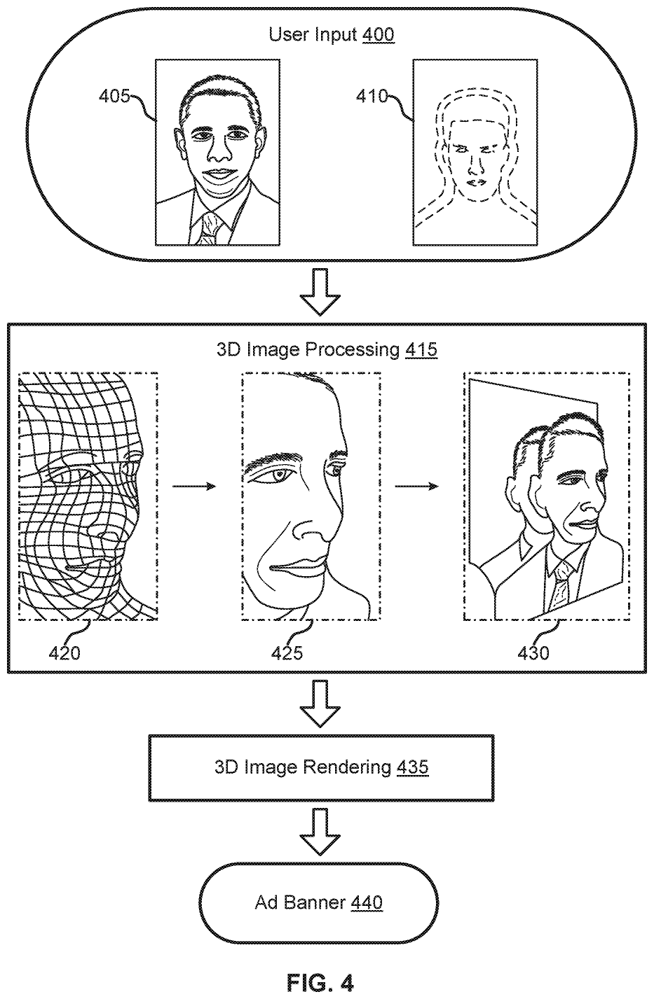

User input 300 may be an example of, or include aspects of, the corresponding element or elements described with reference to FIG. 4. User input 300 may include 2D image 305 and depth map 310 (in some cases, the depth map 310 may be generated automatically based on the 2D image 305).

The 3D image rendering 320 may be built using web-based programming languages such as HTML and JavaScript to make the 3D rendering output accessible for a wide variety of devices that access the internet. Thus, ad banner 325 may be used across a variety of standard and rich media ads or ad platforms.

In some examples, the 3D image processing may include using the depth map 310 to construct a 3D mesh consisting of vertices and edges. Then, color pixels may be mapped to the pixels of the 3D mesh as the texture(s) of the 3D mesh. Finally, if the 3D mesh includes more pixels than the original image (i.e., based on viewing it from another angle), the gaps may be filled in by interpolating colors from the original image (e.g., based on the closest pixels).

After the creation of the colored 3D mesh, 3D image rendering 320 read the 3D mesh as input and render it based on a particular viewing angle (i.e., based on the angle of a mobile device's gyroscope or a desktop mouse's hover position, etc.).

The 3D image rendering 320 is capability of a variety of effects. In one embodiment, the user scrolling a page up or scrolling a page down on the device causes the 3D image on the page to be zoomed in or zoomed out. In one embodiment, the 3D image is initialized in a zoomed out state and the 3D image is below the user's current scroll position. As the user scrolls down to the 3D image, it zooms in to the 3D image. When the user scrolls past the 3D image, the 3D image zooms out as the user continues to scroll down. The scrolling may be on a mobile or desktop device.

In one embodiment, the 3D image automatically pans up, down, left, and/or right even when there is no user input. This shows the user that the image is a 3D image and not just a flat image.

In one embodiment, as the user moves a cursor or other interaction point on the screen, the 3D image pans in that direction. For example, if the user moves the cursor or interaction point to the right, then the view of the 3D image pans to the right. Likewise, the same occurs for moving the cursor or interaction point to the left, up, or down.

2D image 305 may be an example of, or include aspects of, the corresponding element or elements described with reference to FIGS. 4, 7, and 8. Depth map 310 may be an example of, or include aspects of, the corresponding element or elements described with reference to FIGS. 4, 7, and 9.

3D image processing 315, 3D image rendering 320, and ad banner 325 may be an example of, or include aspects of, the corresponding elements or functions described with reference to FIG. 4.

FIG. 3B shows an example of an overview of a process for generating a 3D model 330 from a 2D image 305 and depth map 310. The process is similar to that shown in FIG. 3A includes the same steps of user input 300, 2D image 305, depth map 310, and 3D image processing 315. The 3D image processing 315 generates a 3D model 330. The process of generating the 3D model 330 from the 2D image 305 and depth map 310 is described in further detail herein in FIGS. 4-6.

FIG. 3C shows an example of an ad server 335 and ad banner 350 where 3D model 330 may be used. The 3D model 330 may be generated once and re-used in ad banners that include capabilities for 3D rendering.

In an embodiment, the 3D model 330 is stored on an ad server 335 that serves ad banners 350 or other images or content. The 3D model 330 is served from the ad server 335 to the client devices viewing the ad banners 335 or other images or content. The client device renders the 3D model, using for example the step of 3D images rendering 320. The rendering step causes the model to be viewable as a 3D image in the ad banner 350, images, or other content.

In an embodiment, the ad banner 350 includes the 3D model 330, a rendering unit 340, and an ad experience unit 345. The rendering unit 340 is configured to render the 3D model 330 to the user. The rendering unit 340 may comprise computer code for displaying a 3D model 330. The ad experience unit 345 is configured to provide additional experiences with the ad such as interactivity, ability to move the 3D model 330 or user perspective to view it from different angles, and optional ad overlays.

In some embodiments, the ad server 335 may collect and track metrics about the ad banner 350 such as the amount of time that the user viewed the ad, the number of times or quality of the user's interaction with the ad, or the amount of time that the user hovered over the ad.

FIG. 4 shows an example of a process for generating a 3D image in accordance with aspects of the present disclosure. The example shown includes user input 400, 3D image processing 415, 3D image rendering 435, and Ad Banner 440. Details of the process described in FIG. 4 are similar to those described above with reference to FIG. 3, but FIG. 4 includes example images to illustrate the process.

User input 400 may be an example of, or include aspects of, the corresponding element or elements described with reference to FIG. 3. User input 400 may include 2D image 405 and depth map 410. 2D image 405 may be an example of, or include aspects of, the corresponding element or elements described with reference to FIGS. 3, 7, and 8. Depth map 410 may be an example of, or include aspects of, the corresponding element or elements described with reference to FIGS. 3, 7, and 9.

3D image processing 415 may be an example of, or include aspects of, the corresponding functions described with reference to FIG. 3. For example, 3D image processing 415 may include 3D mesh 420, color mapping 425, and interpolation 430. 3D image rendering 435 and ad banner 440 may be examples of, or include aspects of, the corresponding element and function described with reference to FIG. 3.

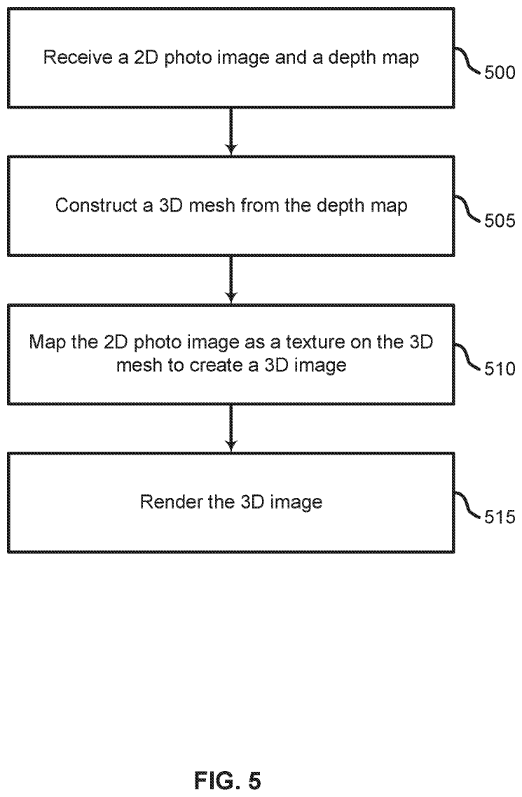

FIG. 5 shows an example of a process for generating and displaying a 3D images in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 500, the system receives a 2D photo image and a depth map. In some cases, the operations of this step may refer to, or be performed by, an input component as described with reference to FIG. 2. For example, the 2D photo image may be uploaded from a client device, and the depth map may be either uploaded or generated based on the 2D photo.

At step 505, the system constructs a 3D mesh from the depth map. In some cases, the operations of this step may refer to, or be performed by, a 3D mesh component as described with reference to FIG. 2. For example, the 3D mesh may include vertices and edges generated based on the depth map.

At step 510, the system maps the 2D photo image as a texture on the 3D mesh to create a 3D image. In some cases, the operations of this step may refer to, or be performed by, a mapping component as described with reference to FIG. 2. For example, colors from the 2D photo image may be mapped as the textures onto the 3D mesh. In some cases, additional textures may be generated by interpolating colors from nearby pixels (i.e., if a viewing angle of the 3D mesh results in occlusion gaps).

At step 515, the system renders the 3D image. In some cases, the operations of this step may refer to, or be performed by, a rendering component as described with reference to FIG. 2. For example, the rendering may be based on a viewing angle of a device (or an inferred viewing angle based on a gyroscope or a mouse position).

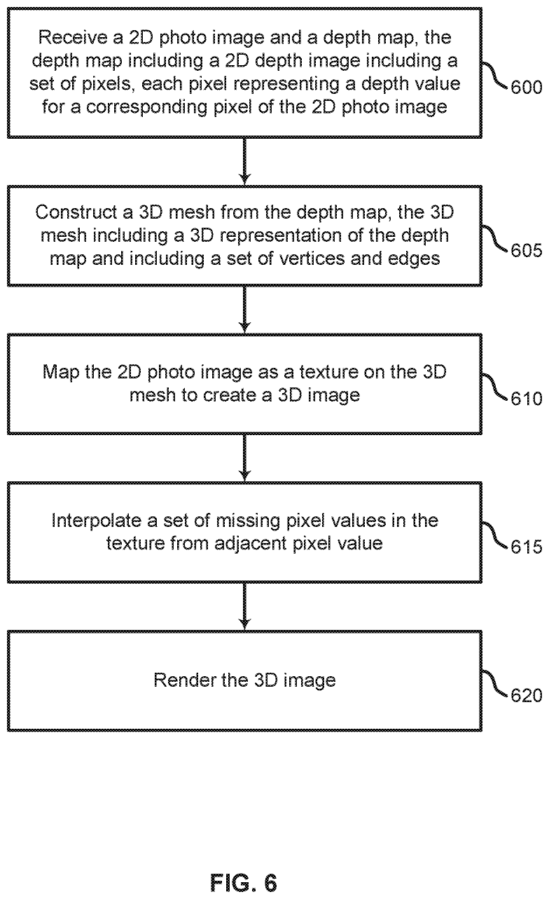

FIG. 6 shows an example of a process for generating and displaying a 3D images in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 600, the system receives a 2D photo image and a depth map, the depth map including a 2D depth image including a set of pixels, each pixel representing a depth value for a corresponding pixel of the 2D photo image. In some cases, the operations of this step may refer to, or be performed by, an input component as described with reference to FIG. 2.

At step 605, the system constructs a 3D mesh from the depth map, the 3D mesh including a 3D representation of the depth map and including a set of vertices and edges. In some cases, the operations of this step may refer to, or be performed by, a 3D mesh component as described with reference to FIG. 2.

At step 610, the system maps the 2D photo image as a texture on the 3D mesh to create a 3D image. In some cases, the operations of this step may refer to, or be performed by, a mapping component as described with reference to FIG. 2.

At step 615, the system interpolates a set of missing pixel values in the texture from adjacent pixel value. In some cases, the operations of this step may refer to, or be performed by, an interpolation component as described with reference to FIG. 2.

At step 620, the system renders the 3D image. In some cases, the operations of this step may refer to, or be performed by, a rendering component as described with reference to FIG. 2.

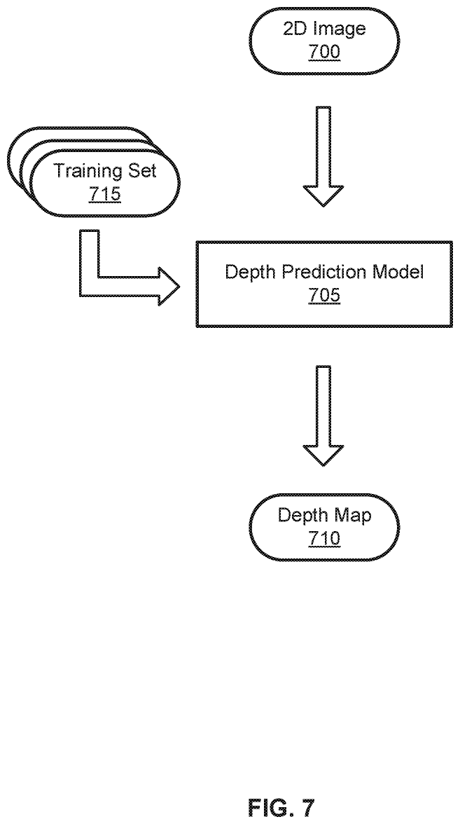

FIG. 7 shows an example of generating a depth map 710 in accordance with aspects of the present disclosure. The example shown includes 2D image 700, depth prediction model 705, depth map 710, and training set 715. The depth prediction model 705 may comprise one or more systems or algorithms that take a 2D image 700 and output a depth map 710. In some cases, the training set 715 includes 2D images and depth maps 710 which can be used to train the depth prediction model 705. Thus, depth prediction model 705 may generate the depth map 710 from the 2D image 700, where the depth prediction model 705 is trained on a dataset of images and corresponding depth maps.

In some cases the depth prediction model 705 may comprise a neural network (NN). A NN may be a hardware or a software component that includes a number of connected nodes (a.k.a., artificial neurons), which may be seen as loosely corresponding to the neurons in a human brain. Each connection, or edge, may transmit a signal from one node to another (like the physical synapses in a brain). When a node receives a signal, it can process the signal and then transmit the processed signal to other connected nodes. In some cases, the signals between nodes comprise real numbers, and the output of each node may be computed by a function of the sum of its inputs. Each node and edge may be associated with one or more node weights that determine how the signal is processed and transmitted.

During the training process, these weights may be adjusted to improve the accuracy of the result (i.e., by minimizing a loss function which corresponds in some way to the difference between the current result and the target result). The weight of an edge may increase or decrease the strength of the signal transmitted between nodes. In some cases, nodes may have a threshold below which a signal is not transmitted at all. The nodes may also be aggregated into layers. Different layers may perform different transformations on their inputs. The initial layer may be known as the input layer and the last layer may be known as the output layer. In some cases, signals may traverse certain layers multiple times. In one example, the training set 715 may include a large number of images as input and a corresponding set of depth maps as the target output.

2D image 700 may be an example of, or include aspects of, the corresponding element or elements described with reference to FIGS. 3, 4, and 8. Depth map 710 may be an example of, or include aspects of, the corresponding element or elements described with reference to FIGS. 3, 4, and 9.

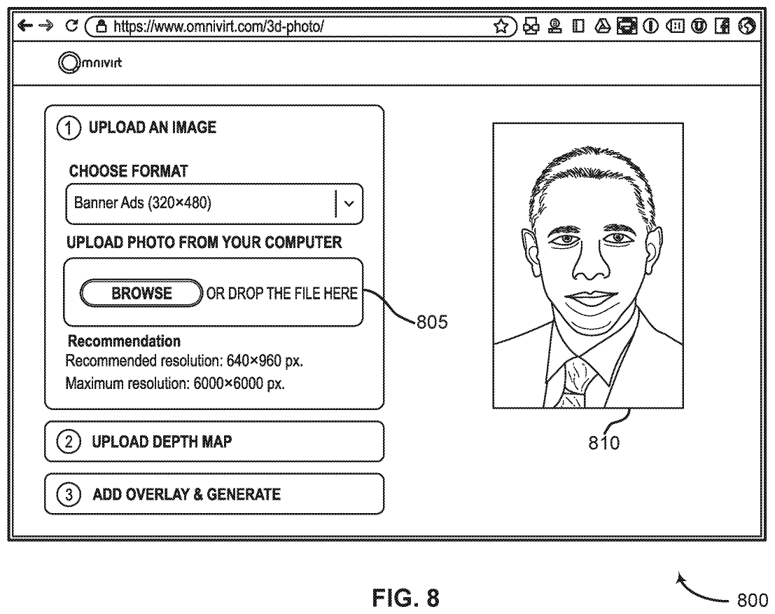

FIG. 8 shows an example of a user interface 800 showing an original 2D image 810 in accordance with aspects of the present disclosure. The user interface 800 may illustrate an interface by which a user may upload a 2D image for use in generating a 3D image (e.g., for an advertisement).

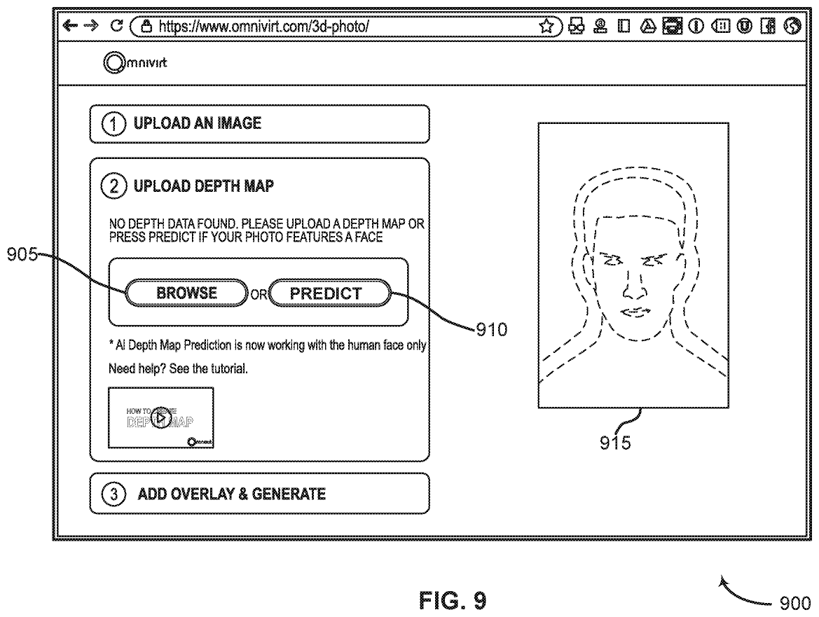

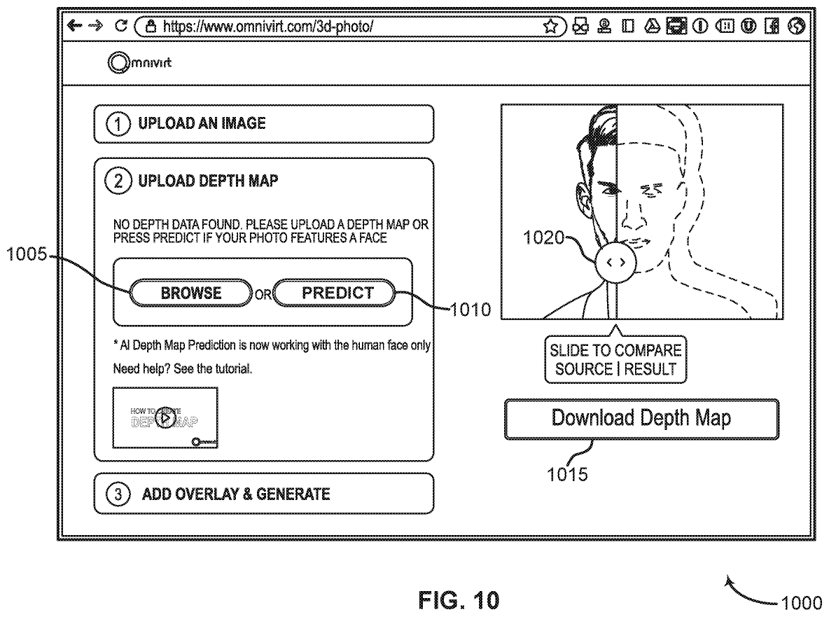

User interface 800 may be an example of, or include aspects of, the corresponding element or elements described with reference to FIGS. 9 and 10. User interface 800 may include 2D image upload element 805 and 2D image 810. 2D image 810 may be an example of, or include aspects of, the corresponding element or elements described with reference to FIGS. 3, 4, and 7.

FIG. 9 shows an example of a user interface 900 showing a depth map 915 in accordance with aspects of the present disclosure. The user interface 900 may illustrate how a depth map 915 may be uploaded by a user for generating a 3D image (e.g., for an advertisement). Additionally or alternatively, the depth map 915 may be generated automatically (e.g., by selecting the depth map prediction element 910).

User interface 900 may be an example of, or include aspects of, the corresponding element or elements described with reference to FIGS. 8 and 10. User interface 900 may include depth map upload element 905, depth map prediction element 910, and depth map 915. In response to a user input to the depth map upload element 905, the user interface 900 may prompt the user to upload a depth map 915 from a local or remote memory. In response to a user input to the depth map prediction element 910, the depth map component may automatically predict a depth map based on an uploaded 2D image.

Depth map upload element 905 and depth map prediction element 910 may be examples of, or include aspects of, the corresponding elements described with reference to FIG. 10. Depth map 915 may be an example of, or include aspects of, the corresponding element or elements described with reference to FIGS. 3, 4, and 7.

FIG. 10 shows an example of a user interface 1000 showing a slider element 1020 in accordance with aspects of the present disclosure. The user interface 1000 illustrates a slider element 1020 which may be used to smoothly alternate between the a 2D image view and a depth map view. The portion to one side of slider element 1020 shows the pixels of the 2D image and the portion on the opposite side of slider element 1020 shows the pixels of the depth map. In response to receiving user input to the slider, the image is cleanly wiped between the 2D image and the depth map. The user interface 1000 also shows a depth map download element 1015, which may be used to download a depth map.

User interface 1000 may be an example of, or include aspects of, the corresponding element or elements described with reference to FIGS. 8 and 9. User interface 1000 may include depth map upload element 1005, depth map prediction element 1010, depth map download element 1015, and slider element 1020.

Depth map upload element 1005 and depth map prediction element 1010 may be examples of, or include aspects of, the corresponding elements described with reference to FIG. 9.

Accordingly, the present disclosure includes the following embodiments.

A computer-implemented method for generating and displaying a three dimensional (3D) images is described. The computer-implemented method may include receiving a two dimensional (2D) photo image and a depth map, the depth map comprising a 2D depth image including a plurality of pixels, each pixel representing a depth value for a corresponding pixel of the 2D photo image, constructing a 3D mesh from the depth map, the 3D mesh comprising a 3D representation of the depth map and comprising a plurality of vertices and edges, mapping the 2D photo image as a texture on the 3D mesh to create a 3D image, interpolating a plurality of missing pixel values in the texture from adjacent pixel value, and rendering the 3D image.

An apparatus for generating and displaying a 3D images is described. The apparatus may include a processor, memory in electronic communication with the processor, and instructions stored in the memory. The instructions may be operable to cause the processor to receive a 2D photo image and a depth map, the depth map comprising a 2D depth image including a plurality of pixels, each pixel representing a depth value for a corresponding pixel of the 2D photo image, construct a 3D mesh from the depth map, the 3D mesh comprising a 3D representation of the depth map and comprising a plurality of vertices and edges, map the 2D photo image as a texture on the 3D mesh to create a 3D image, interpolate a plurality of missing pixel values in the texture from adjacent pixel value, and render the 3D image.

A non-transitory computer readable medium storing code for generating and displaying a 3D images is described. In some examples, the code comprises instructions executable by a processor to: receive a 2D photo image and a depth map, the depth map comprising a 2D depth image including a plurality of pixels, each pixel representing a depth value for a corresponding pixel of the 2D photo image, construct a 3D mesh from the depth map, the 3D mesh comprising a 3D representation of the depth map and comprising a plurality of vertices and edges, map the 2D photo image as a texture on the 3D mesh to create a 3D image, interpolate a plurality of missing pixel values in the texture from adjacent pixel value, and render the 3D image.

Some examples of the computer-implemented method, apparatus, and non-transitory computer readable medium described above may further include receiving the depth map as an uploaded file from a user. Some examples of the computer-implemented method, apparatus, and non-transitory computer readable medium described above may further include generating, by a machine learning depth prediction model, the depth map from the 2D photo image, wherein the machine learning depth prediction model is trained on a dataset of images and corresponding depth maps.

Some examples of the computer-implemented method, apparatus, and non-transitory computer readable medium described above may further include displaying a visual element, the visual element including a portion of the 2D photo image and a portion of the depth map. Some examples may further include displaying a slider on top of the visual element, wherein the slider is configured to be adjustable and allow increasing and decreasing the area of the visual element comprising the 2D photo image and the depth map.

In some examples, the depth map is generated simultaneously with the 2D photo image by a camera with a depth sensing system. Some examples of the computer-implemented method, apparatus, and non-transitory computer readable medium described above may further include displaying the 3D image in an online banner advertisement.

Some examples of the computer-implemented method, apparatus, and non-transitory computer readable medium described above may further include receiving user input in a web browser and changing a user viewpoint for viewing the 3D image in response to the user input. Some examples of the computer-implemented method, apparatus, and non-transitory computer readable medium described above may further include displaying the 3D image using HTML5 and JavaScript.

Some examples of the computer-implemented method, apparatus, and non-transitory computer readable medium described above may further include transmitting the online banner advertisement to an online advertising network. Some examples may further include receiving payment from the online advertising network per click on the online banner advertisement.

Some examples of the computer-implemented method, apparatus, and non-transitory computer readable medium described above may further include receiving the 2D photo image as an uploaded file from a user. Some examples may further include receiving the depth map as an uploaded file from the user. Some examples may further include receiving a selection of a banner ad format by the user. Some examples may further include receiving a user input to initiate generation of the 3D image.

Some examples of the computer-implemented method, apparatus, and non-transitory computer readable medium described above may further include displaying a 2D overlay on top of the 3D image, the 2D overlay including one or more interactive use interface elements.

A computer-implemented method for generating and displaying a 3D images is described. The computer-implemented method may include receiving a 2D photo image and a depth map, constructing a 3D mesh from the depth map, mapping the 2D photo image as a texture on the 3D mesh to create a 3D image, and rendering the 3D image.

An apparatus for generating and displaying a 3D images is described. The apparatus may include a processor, memory in electronic communication with the processor, and instructions stored in the memory. The instructions may be operable to cause the processor to receive a 2D photo image and a depth map, construct a 3D mesh from the depth map, map the 2D photo image as a texture on the 3D mesh to create a 3D image, and render the 3D image.

A non-transitory computer readable medium storing code for generating and displaying a 3D images is described. In some examples, the code comprises instructions executable by a processor to receive a 2D photo image and a depth map, construct a 3D mesh from the depth map, map the 2D photo image as a texture on the 3D mesh to create a 3D image, and render the 3D image.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

In general, the terms “engine” and “module”, as used herein, refer to logic embodied in hardware or firmware, or to a collection of software instructions, possibly having entry and exit points, written in a programming language, such as, for example, Java, JavaScript, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on one or more computer readable media, such as a compact discs, digital video discs, flash drives, or any other tangible media. Such software code may be stored, partially or fully, on a memory device of the executing computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method for generating and displaying a three dimensional (3D) image, the method comprising:
receiving a two dimensional (2D) photo image and a depth map, the depth map comprising a 2D depth image including a plurality of pixels, each pixel representing a depth value for a corresponding pixel of the 2D photo image;
constructing a 3D mesh from the depth map, the 3D mesh comprising a 3D representation of the depth map and comprising a plurality of vertices and edges;
mapping the 2D photo image as a texture on the 3D mesh to create a 3D image;
interpolating a plurality of missing pixel values in the texture from adjacent pixel value; and
rendering the 3D image.

2. The computer-implemented method of claim 1, further comprising:
receiving the depth map as an uploaded file from a user.

3. The computer-implemented method of claim 1, further comprising:
generating, by a machine learning depth prediction model, the depth map from the 2D photo image, wherein the machine learning depth prediction model is trained on a dataset of images and corresponding depth maps.

4. The computer-implemented method of claim 3, further comprising:
displaying a visual element, the visual element including a portion of the 2D photo image and a portion of the depth map; and
displaying a slider on top of the visual element, wherein the slider is configured to be adjustable and allow increasing and decreasing the area of the visual element comprising the 2D photo image and the depth map.

5. The computer-implemented method of claim 1, wherein:
the depth map is generated simultaneously with the 2D photo image by a camera with a depth sensing system.

6. The computer-implemented method of claim 1, further comprising:
displaying the 3D image in an online banner advertisement.

7. The computer-implemented method of claim 6, further comprising:
receiving user input in a web browser and changing a user viewpoint for viewing the 3D image in response to the user input;
displaying the 3D image using HTML5 and Javascript.

8. The computer-implemented method of claim 7, further comprising:
transmitting the online banner advertisement to an online advertising network; and
receiving payment from the online advertising network per click on the online banner advertisement.

9. The computer-implemented method of claim 1, further comprising:
receiving the 2D photo image as an uploaded file from a user;
receiving the depth map as an uploaded file from the user;
receiving a selection of a banner ad format by the user; and
receiving a user input to initiate generation of the 3D image.

10. The computer-implemented method of claim 1, further comprising:
displaying a 2D overlay on top of the 3D image, the 2D overlay including one or more interactive use interface elements.

11. An apparatus for generating and displaying a three dimensional (3D) images, comprising: a processor and a memory storing instructions and in electronic communication with the processor, the processor being configured to execute the instructions to:
receive a two dimensional (2D) photo image and a depth map, the depth map comprising a 2D depth image including a plurality of pixels, each pixel representing a depth value for a corresponding pixel of the 2D photo image;
construct a 3D mesh from the depth map, the 3D mesh comprising a 3D representation of the depth map and comprising a plurality of vertices and edges;
map the 2D photo image as a texture on the 3D mesh to create a 3D image;
interpolate a plurality of missing pixel values in the texture from adjacent pixel value; and
render the 3D image.

12. The apparatus of claim 11, the processor being further configured to execute the instructions to:
receive the depth map as an uploaded file from a user.

13. The apparatus of claim 11, the processor being further configured to execute the instructions to:
generate, by a machine learning depth prediction model, the depth map from the 2D photo image, wherein the machine learning depth prediction model is trained on a dataset of images and corresponding depth maps.

14. The apparatus of claim 13, the processor being further configured to execute the instructions to:
display a visual element, the visual element including a portion of the 2D photo image and a portion of the depth map; and
display a slider on top of the visual element, wherein the slider is configured to be adjustable and allow increasing and decreasing the area of the visual element comprising the 2D photo image and the depth map.

15. The apparatus of claim 11, wherein:
the depth map is generated simultaneously with the 2D photo image by a camera with a depth sensing system.

16. The apparatus of claim 11, the processor being further configured to execute the instructions to:
display the 3D image in an online banner advertisement.

17. The apparatus of claim 16, the processor being further configured to execute the instructions to:
receive user input in a web browser and changing a user viewpoint for viewing the 3D image in response to the user input;
display the 3D image using HTML5 and Javascript.

18. The apparatus of claim 17, the processor being further configured to execute the instructions to:
transmit the online banner advertisement to an online advertising network; and
receive payment from the online advertising network per click on the online banner advertisement.

19. The apparatus of claim 11, the processor being further configured to execute the instructions to:
receive the 2D photo image as an uploaded file from a user;
receive the depth map as an uploaded file from the user;
receive a selection of a banner ad format by the user; and
receive a user input to initiate generation of the 3D image.

20. The apparatus of claim 11, the processor being further configured to execute the instructions to:
display a 2D overlay on top of the 3D image, the 2D overlay including one or more interactive use interface elements.
